(19) United States
(12) Patent Application Publication
(10) Pub. No.: US 2003/0020902 A1
(43) Pub. Date: Jan. 30, 2003

(54) Method for inspection of optical elements

(76) Inventors: Yonathan Japha, Rehovot (IL); Yehuda Ben-Ami, Rosh Ha'Ayin (IL)

Correspondence Address: LASERCOMM, INC., INTELLECTUAL PROPERTY DEPT., 2600 TECHNOLOGY DRIVE SUITE 900, PLANO, TX, 75074, US

(21) Appl. No.: 10/187,002

(22) Filed: Jul. 2, 2002

Related U.S. Application Data
(60) Provisional application No. 60/305,856, filed on Jul. 18, 2001.

(51) Int. Cl. G01B 9/00

(52) U.S. Cl. 356/124

(57) ABSTRACT

An optical inspection apparatus and method for optical elements. The apparatus comprises a surface profiler in data communication with a computing platform, and utilizes an overlap integral between an expected output field based on the designed profile and the calculated output field based on the measured profile. The overlap integral is utilized in one embodiment to calculate the expected loss of the optical element. In another embodiment, the overlap integral is utilized to calculate the amount of undesired wave function. The method an apparatus are useful for both flat and curved dielectric materials and may be utilized with both reflecting and non-reflecting surfaces.

### CROSS-REFERENCE TO RELATED APPLICATIONS

The present application claims the benefit of the filing date of copending U.S. Provisional Application, Ser. No. 60/305,856 filed Jul. 18, 2001, entitled “Method for Optical Inspection of Elements”.

### BACKGROUND OF THE INVENTION

The invention relates generally to optical elements and more particularly to a method for inspection and evaluation of optical elements. Optical elements, in particular diffractive elements, must be inspected to ensure that they meet the desired profiles. In prior art systems this is often accomplished by measuring the optical fields near the output of the components or by measuring the surfaces using mechanical contact measurement devices, optical point measurement devices, or an optical microscopes such as an interferometric microscopes. Interferometric microscopes are capable of measuring the surface roughness and height profile of an optical element. The software provided with the microscope usually enables the operator to examine the topography of the entire element or a section of the element, which may be then compared with the desired profile. Typically this comparison gives the operator a visual feedback regarding the quality of manufacturing and the operator thus makes a judgment as to the acceptability of the measured component.

Certain imperfections may have little impact on the actual system performance, however a strict visual feedback method cannot take this into account. In many circumstances, differing regions of the surface have different impact as to the ultimate performance of an optical system built with the element. It is quite difficult to give different weightings to variations of the surface profile in differing regions utilizing strict visual feedback. There is therefore a long felt need for an automated method of finding the differential between a desired surface profile and a measured one, which allows for different weightings for different regions, and that is capable of indicating the exact points of error together with the expected performance degradation due to the imperfections.

### SUMMARY OF THE INVENTION

The aforementioned needs are addressed, by utilizing an overlap integral between the expected output wave function based on the designed surface profile and the output wave function calculated for the measured surface profile. The overlap integral takes into account the weighting function of the field intensity.

The invention relates to a method of inspection of optical elements and particularly a method of determining the relative quality of the element with respect to the designed element, taking into account the actual operation of the element. The method comprises the steps of loading a file containing the expected output field based on the designed profile, loading a file containing an expected input field, acquiring the actual profile of the optical element being inspected, calculating the output field based on the actual profile performing an overlap integral between the expected output field based on the design profile and the calculated output field based on the acquired profile. In a preferred embodiment, the file containing the expected output field is replaced with a file containing the designed profile, and the expected output field is calculated utilizing the expected input field and the designed profile.

In an exemplary embodiment a grade is calculated as a function of the overlap integral. Preferably the grade is the calculated loss in expressed in a logarithmic scale such as dB, or in another embodiment the grade is a function of the calculated loss converted to a linear scale. In another preferred embodiment the grade is a measure of unwanted wave functions.

In a preferred embodiment the actual profile is acquired through an interferometric microscope. In some embodiments the optical element exhibits circular symmetry, a nominally flat dielectric surface, a curved dielectric surface, a reflective surface, a diffractive surface, a refractive surface or a substantially transmissive surface.

In another embodiment the invention comprises an apparatus for inspecting optical components. The apparatus comprises a surface profiler capable of measuring the actual surface profile of the optical element and a computing platform in data communication with the surface profiler. The computing platform loads a file containing the expected output field based on the designed profile, a file containing an expected input field, and utilizing the surface profile to acquire the actual profile of the optical element being inspected, calculates the output field based on the actual profile and then performs an overlap integral between the expected output field based on the design profile and the calculated output field based on the acquired profile. In a preferred embodiment, the file containing the expected output field is replaced with a file containing the designed profile, and the expected output field is calculated utilizing the expected input field and the designed profile.

In a preferred embodiment the surface profiler comprises an interferometric microscope. Preferably the apparatus further comprises a display for displaying a function of the overlap integral indicating a grade for the optical element being inspected. In one embodiment the grade is the calculated loss in a logarithmic scale, such as dB.

### BRIEF DESCRIPTION OF THE DRAWINGS

The above and further advantages of the present invention may be better understood by referring to the following description taken in conjunction with the accompanying drawings in which like numerals designate corresponding elements or sections throughout, and in which:

FIG. 1 depicts a high level block diagram of an optical inspection station containing an interferometric micropscope;

FIG. 2 depicts a high level flow chart of the main routine, and

FIG. 3 depicts a high level flow chart of a centering routine.

### DETAILED DESCRIPTION OF THE INVENTION

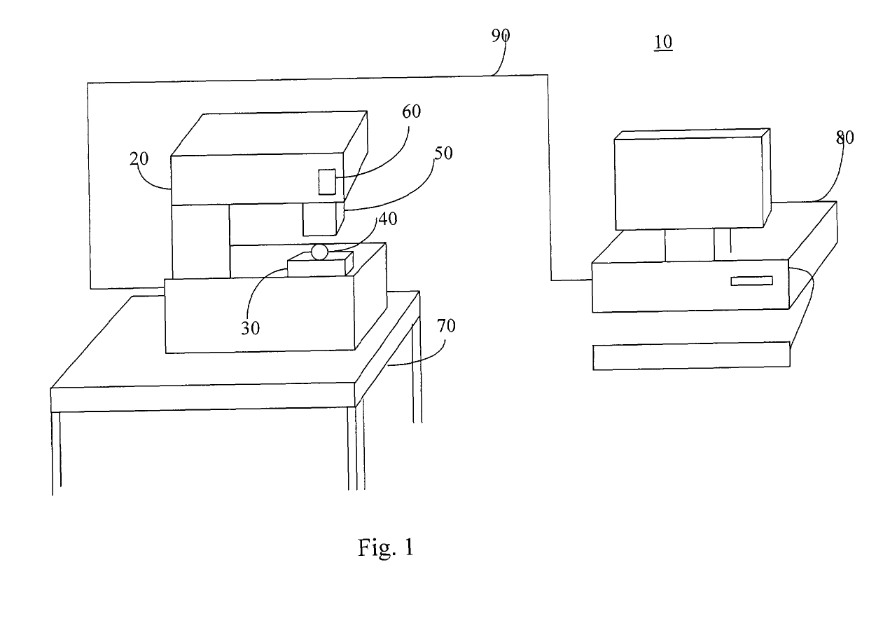

FIG. 1 illustrates a high level block diagram of a system 10 utilized to inspect optical elements, such as optical element 40, and comprises interferometric microscope 20, computing platform 80 and data connection 90. Interferometic microscope 20 comprises optical inspection platen 30, microscope objective 50, adjustable field of view control 60 and floating optical table 70. In an exemplary embodiment interferometric microscope 20 comprises a Wyko NT1000 series optical profiler available from Veeco Instruments, Inc., Plainview, N.Y., or any other optical microscope capable of creating a digital output of a 3 dimensional surface profile. The invention will be described in connection with an interferometric microscope, however this is not meant to be limiting in any way, and the invention is equally applicable to other methods of obtaining a 3 dimensional surface profile, and in particular to the use of a contact profiler.

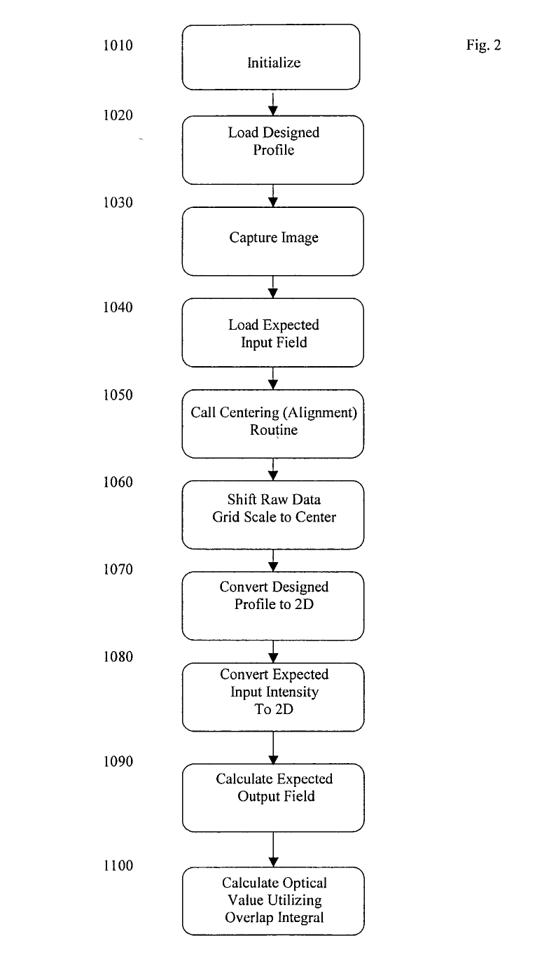

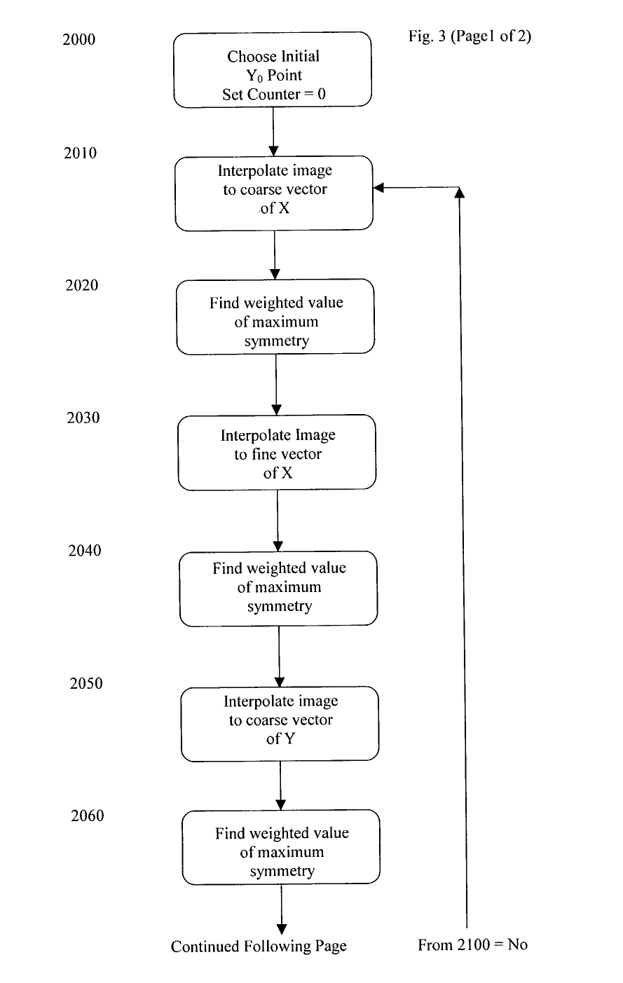

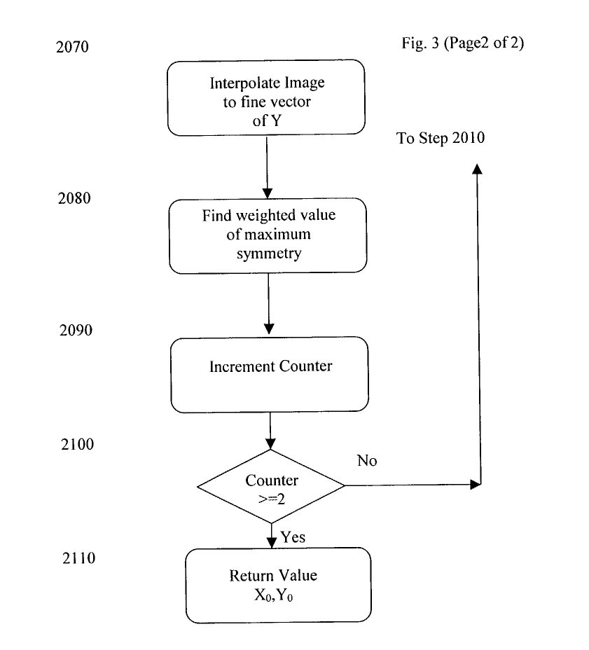

In operation, optical element 40 to be inspected is placed on the optical inspection platen 30 of interferometric microscope 20. Interferometric microscope 20 is operated in a manner known to those skilled in the art to obtain a representation of the surface profile of the element, and the representation of the surface profile is sent to computing platform 80 through data connection 90. Computing platform 80 comprises any suitable computing platform, including but not limited to a personal computer. The program can be written in any suitable programming language. In an exemplary embodiment the program is written in Matlab, available from The Mathworks, Inc. of Natick, Mass. Data from optical microscope 20 is transferred to computing platform 80 through data connection 90, which in one embodiment comprises a network connection. In another embodiment a direct connection is utilized. In yet another embodiment, computing platform 80 is collocated within interferometric microscope 20, and data connection 90 comprises an internal connection. Computing platform 80 contains the program whose operation will be described below in relation to FIGS. 2 and 3.

The method will be described in detail in relation to an optical element exhibiting circular symmetry, however this is not meant to be limiting in any way. In particular, different methods of alignment known to those skilled in the art are utilized in connection with optical elements which do not exhibit circular symmetry.

FIG. 2 illustrates a high level block diagram of a first embodiment of a suitable program in accordance with the subject invention to be operated on computing platform 80. The program begins in step 1010, where the system is initialized, in which among other items the wavelength to be utilized for the element operation and the refractive index of the element is loaded. In step 1020 a file containing the designed profile is loaded. For a symmetric circular element, the designed profile is typically a one dimensional graph showing profile height vs. radial distance. In the event that the element 40 does not exhibit circular symmetry, the designed profile may consist of a series of functions defining the surface height, or a listing of points with their respective heights.

In step 1030 the two dimensional image, comprising height data for each location, from the interferometric microscope 20 is captured and an X,Y grid is assigned to the raw image data such that an initial X=0 and Y=0 corresponds to a predetermined point. In one embodiment the predetermined point corresponds to the lower-left corner of the raw image data grid.

In step 1040 a file containing the expected field at the input to the optical element 40 is loaded. The invention is herewith being illustrated in connection with a nominally flat dielectric element, and thus only the intensity of the input field is required. For a non-flat dielectric element, the entire input field function may be required, as will be understood by those skilled in the art. In an exemplary embodiment the expected field intensity comprises a one dimensional graph showing intensity vs. radial distance, and may be produced as part of the design process. At the minimum a Gaussian estimation is utilized.

In step 1050 the centering or alignment routine is run to find the coordinates of the center of the element on the X,Y scale of the raw data grid, and the routine returns the center point as X₀,Y₀. An exemplary embodiment of a centering routine suitable for use with the invention for an optical element 40 exhibiting circular symmetry will be described further below in relation to FIG. 3. The particular centering routine utilized is not meant to be limiting in any way, but is meant by way of illustration of a particular method. Other methods are known to those skilled in the art of image processing. As previously indicated, in the event that the element does not exhibit circular symmetry, alternative methods of finding the appropriate reference points must be utilized. These methods are well known to those skilled in the art.

The center of raw image data for element 40 has now been found, and is set to X₀, Y₀. In step 1060 the X,Y scale of the raw image data grid is shifted so that the center of the element is located at (X₀,Y₀)=(0,0) of the new X,Y scale. Thus the image center is now collocated with the center of the X,Y grid.

In step 1070, the design profile loaded in step 1020 is converted to a two dimensional profile whose center is located at the point 0,0 of the X,Y axis. In the exemplary embodiment, this is accomplished by interpolating the profile height given as a function of radius into the X,Y coordinates of the raw image data grid.

In step 1080 the expected input field intensity loaded in step 1040 is converted into a two dimensional intensity profile, by interpolating its values onto the raw image data grid, while setting the center point to 0,0 of the X,Y axis. In the exemplary embodiment, this is accomplished by interpolating the intensity given as a function of radius into the X,Y coordinates of the raw image data grid. The input intensity profile is normalized so that the integral of the intensity over the whole grid is equal to one (1).

The design profile, and the measured profile are now on the same grid, with the measured profile being centered at the same point as the design profile. One measurement that can be made is the differential in height between the design and measured profile, and for any variance over a certain amount the element can be identified as not acceptable. However as indicated above this is not desirable, as certain variance have little or no effect on the optical performance of the element.

In step 1090 the designed wave function at the output of the optical element 40 is calculated utilizing the loaded designed profile of step 1020 and the loaded input field 1040. This is accomplished mathematically by letting f be the desired output wave function. For a nominally flat dielectric element the function representing the amplitude and phase of the desired wave function after the designed element is:

f(x,y)=fᵢₙ(x,y)·e^{i2π(n-1)z/λ} Equation 1

where z is the designed profile height, n is the refractive index of the designed optical element, and fᵢₙ(x,y) represents the expected input wave function, as described in connection with step 1080. In an alternative embodiment (not shown) the designed wave function at the output of the optical element 40 for the expected input field loaded at 1040 is loaded directly in step 1020. In this embodiment, step 1090 is not run, and the program proceeds with step 1100.

One measurement that can be made at this point is the differential in height between the design and measured profile, weighted by the desired intensity corresponding to the wave function of Equation 1. Such an output will show the operator key areas that will have a significance to the resultant wave function, and can be used as a feedback to correct the production process. This however is insufficient information for a pass/fail criteria, as the operator is not yet aware of the resultant significance of the deviation from the designed profile. It is therefore desirable, to calculate an optical value for the performance of the measured element in comparison with the performance of the designed element.

In step 1100 this is accomplished by comparing the designed wave function at the output of the optical element 40 with the calculated wave function of the measured optical element 40 as will be described below. Let f′ the expected wave function which is calculated based on the measured profile. The relationship between the expected wave function based on the designed profile and that based on the measured profile may be described by the equation

f′=af+δf Equation 2

where a is the proportionality factor and δf is the part of the wavefront that is not proportional to f, i.e. it is orthogonal to f and comprises all the undesired field components. In one embodiment δf comprises both field components that are of particular concern and field components that are not of concern—i.e. field components whose presence or absence will not materially affect the operation of the element. In another embodiment δf is a null function, and there are no specific undesired field components. Since a is the proportionality factor, |a|² represents light intensity (proportional to energy flux) in the specific desired wave function f. For nominally flat dielectric elements the wave function after the measured profile is:

f′(x,y)=fᵢₙ(x,y)·e^{i2π(n-1)z′/λ} Equation 3

where z′ is the measured profile height.

It should be noted that equation 1 and equation 3 are particularly good approximations for relatively flat dielectric elements, wherein the light rays are substantially normally incident to the plane of the element. It should also be noted that equations 1 and 3 are to be modified for an optical element comprising reflective surfaces by replacing the factor (n−1) with the factor 2. For curved or tilted dielectric elements, a simulation must be performed utilizing the expected input field. The simulation must arrive at the expected output field for both the designed element, as well as the measured element, and is known to those skilled in the art.

The loss attributable to the element, or more precisely to the difference between the desired profile and the measured profile can be expressed in a logarithmic scale as:

Loss=10log₁₀|a|² Equation 4

If there is no significant random scattering or absorption in the system, then we also know that the total field energy of both the ideal field, and the field from the measured profile should be the same, and we set this arbitrarily equal to 1 as:

∫∫dxdy|f(x,y)|²=∫∫dxdy|f′(x,y)|²=1 Equation 5

The energy that was lost into undesired wave functions, if any, is given by

∫∫dxdy|δf(x,y)|²=1−|a|² Equation 6

As stated above, the light intensity of the desired wave functions is equal to |a|². The proportionality factor a is given by the overlap integral of the expected field based on the measured profile f′(x,y) and f*(x,y), where f*(x,y) is the complex conjugate of the expected field for the designed profile. Utilizing the orthogonality of δf and f, and equations 1 and 5, the proportionality factor a is therefore:

a=∫∫dxdy f*(x,y)·f′(x,y) Equation 7

Combining equation 2 and equation 3 into equation 7, and substituting into equation 4 yields the expression for loss in relatively flat dielectric elements as:

Loss=10log₁₀|∫∫dxdy|fᵢₙ(x,y)|²·e^{i2π(n-1)(z′-z)/λ}|² Equation 8

The above can be accomplished using numerical integration.

The loss calculated from equation 8 is expressed in dB, and based on the final use of optical element 40 an appropriate measure of acceptableness is determined. In the event that loss is the key criteria for the element, this optical value is displayed to the user at the output of step 1100. In an alternative embodiment, the loss in dB calculated in equation 8 is converted to a scale of 0 to 100 as:

$$Grade = 100 {( \frac{b}{b - Loss} )}^{1 / 4} , \qquad Equation 9$$

where b may be chosen to scale the grade appropriately. In an exemplary embodiment, b=0.05.

In the event that the element fails the inspection, the element measured data (after centering) and the designed data are reviewed, and the differences are shown to the operator as a two dimensional picture. The operator may also take a section of the element through the center or a section at a circle with a given radius around the center. Furthermore, as mentioned above, the operator may view the differences in data height weighted by the expected output function in order to identify key areas in which improvement is required.

While the above has been described in relation to loss as the key criterion, it will be understood by those skilled in the art that other criteria such as percentage of a particular undesired wave function may be substituted for loss. In the case of a single particular wave function, this is accomplished by optimizing the overlap integral of the calculated undesired wave function based on the design and the expected actual wave function calculated on the basis of the measured element.

Referring to FIG. 3 we find a high level flow chart of a suitable centering or alignment routine for circularly symmetric optical elements 40. The centering routine is well suited for use with elements where the image data is highly symmetric around a central point. For other element types, many centering routines are known to those versed in the art and may be utilized. In another embodiment, particularly well suited to non-circularly symmetric elements, an alignment routine is utilized in place of the centering routine.

The routine of FIG. 3 is used to find the center of the acquired image and its coordinates will be returned as X₀, Y₀. In step 2000 an initial point on the Y axis is chosen in the center of the acquired raw image data grid and saved as the initial Y₀ point. The counter is set to zero. In step 2010 a coarse vector of X values is chosen and the values of the acquired image are interpolated to the values of the coarse X grid at the Y value Y₀. The number of points in the coarse vector is chosen such that the main features of the element's surface are captured. In an exemplary embodiment the coarse vector is chosen to include 200 points. The values of the coarse X vector are arrived at by interpolation from the raw data grid. Any dead points in the raw data are ignored for the interpolation, and only good data points are utilized in the interpolation to the vector. It is to be understood the dead points may occur from a number of different sources, including but not limited to failure of some imaging sensor points, and sharp profile changes.

In step 2020 all the values along the coarse X vector are examined looking for maximum symmetry, while taking into account the expected field intensity, as loaded in step 1040, and as will be described further. In an exemplary embodiment, placement of the optical element 40 is carefully controlled so that the midpoint of the element is known to be very near the center of the raw data grid. The midpoint of the coarse vector is taken as an initial estimate of the central point, and all the points at ¼ of the length of the axis on either side of the central point are examined. In the event that the location of the element center is not carefully controlled, all the points of the entire course vector are examined. The difference between the values at points at equal distances from the examined point is taken, the difference is squared and multiplied by the expected field intensity at the same distance from the center of the element. The sum over all points at equal distances from the examined point is then taken. The procedure looks for the examined point that gives the minimum value of this sum.

To clarify this step in mathematical terms, we will call Sᵢ the symmetry value at point i, the point being examined, and a is distance between any two points on the coarse vector. j is the index of the number of vector points from the examination point, and varies from 1 to a number at which there are no further valid data points on the coarse vector in one direction, and Z is the height of the element at the location as read from the vector points. Iⱼ is the expected intensity of the field at a distance a*j from the point i, with i being the expected center, and the weighted symmetry is calculated as:

$${S}_{i} = {\sum }_{j = 1}^{end} {I}_{j} \cdot {( {Z}_{i + j} - {Z}_{i - j} )}^{2} \qquad Equation 10$$

As indicated above, assuming good initial centering, we allow i to vary over ¼ of the length of the vector in either direction from the point being examined. Finding the minimum value for Sᵢ, over the range of ¼ of the length of the axis on either side of the initial estimate, will give the point of maximum symmetry. The value of X₀ is set to the value of the point of maximum symmetry. In the embodiment in which good initial centering can not be assured, i will vary over the range of possible locations.

Once the best X value is found on the coarse vector and set to an initial X₀, in step 2030 the captured image is interpolated onto a fine vector, in a manner similar to the procedure of step 2010. The fine vector is chosen such that the central symmetry point is found to an accuracy of at least ¼ of the raw image grid separation. In an exemplary embodiment the number of fine grid points is chosen to be 3000 points. The values of the acquired raw data image are interpolated to the values of the fine X grid at the Y value Y₀. Any dead points in the raw data are ignored for the interpolation.

Step 2040 is run, in a manner similar to that described in relation to step 2020, to find the maximum symmetry point using the fine grid. In order to minimize computation time, while maintaining accuracy, only points near the found coarse point are examined. At a minimum the number of points on the fine grid represent approximately 1.5 coarse points. In an exemplary embodiment twenty points on either side of coarse point are utilized. The formula of Equation 10 is utilized, and the resulting point is designated the current X₀.

Now that the most symmetric point on the X axis has been found, the program operates in a similar manner to find the most symmetric point on the Y axis.

In step 2050, the X₀ value found in step 2040 is utilized, and a coarse vector of Y values is chosen. The values of the acquired image are interpolated to the values of the coarse Y grid at the X value X₀. The number of points in the coarse vector is chosen, in the same manner described above in relation to step 2010, such that the main features of the element's surface are captured. In an exemplary embodiment the coarse vector is chosen to include 200 points. The values of the coarse vector are arrived at by interpolation from the raw image data grid. Any dead points in the raw data are ignored for the interpolation.

In step 2060 the procedure similar to that described in relation to step 2020 is run for the coarse Y grid, and the resultant most symmetric position, i.e. the minimum value of S₁ as found utilizing Equation 10, is defined as Y₀.

In step 2070 the captured image is interpolated onto a fine grid, or vector, in a manner similar to the procedure of step 2030. The fine vector is chosen such that the central symmetry point is found to an accuracy of at least ¼ of the raw image grid separation. In an exemplary embodiment the number of fine grid points is chosen to be 3000 points. The values of the acquired image are interpolated to the values of the fine Y grid at the X value X₀. Any dead points in the raw data are ignored in doing the interpolation.

Step 2080 operates in a manner similar to that described in relation to step 2020, to find the maximum symmetry point using the fine grid. In order to minimize computation time, while maintaining accuracy, only points near the found coarse point Y₀ are examined. At a minimum the number of points on the fine grid represent approximately 1.5 coarse points. In an exemplary embodiment twenty points on either side of coarse point are utilized. The formula of Equation 10 is utilized, and the resulting point is designated the current Y₀.

In one embodiment (not shown), the program would run until the location has not changed between each iteration. In an exemplary embodiment due to good centering and symmetry of the optical parts, the algorithm runs for a predetermined number of passes. In an exemplary embodiment the correct location is determined in two passes. Thus, in the exemplary embodiment, in step 2090 we increment the counter. In step 2100 we check the counter and compare its value to 2. If the value is greater than or equal to 2, the program proceeds to step 2110, in which step the found values of X₀, Y₀ are returned to the main program and the routine terminates. If the counter value is less than 2, the program continues with step 2010, which will run the centering routine steps an additional time. It is to be understood by those skilled in the art that the routine can be set to run for more than 2 times, depending on the element and other experimental factors.

The above method and equations have been described in relation to a flat surface, however this is not meant to be limiting in any way. The method is equally applicable for element comprising a curved dielectric surface, a reflective surface, a refractive surface or a diffractive surface. For a non-flat surface, the procedure is fundamentally the same, with an additional step of defining a reference plane away from the element. Propagation is then simulated form the designed surface to arrive at f(x,y), and propagation is simulated from the measured surface to arrive at f′(x,y).

The above method has been described in relation to using an interferometric microscope, however this is not mean to be limiting in any way. The method is equally applicable to the use of other profilers, specifically including those based on triangulation techniques, chromatic techniques, and contact measuring apparatus for measuring surface features, including stylus profiler or any other means that measure actual surface features of a dielectric element.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

We claim:

1. A method of inspecting an optical element comprising the steps of:
loading an expected input field to the optical element;
loading an expected design output field;
acquiring the actual profile of the optical element;
calculating an expected actual output field based on said actual profile, and
calculating an overlap integral between said expected design output field and said expected actual output field.

2. The method of claim 1 in which the step of loading an expected design output field further comprises the steps of:
loading a design profile, and
calculating an expected design output field.

3. The method of claim 1 further involving the step of assigning a grade to said optical element, said grade being a function of said overlap integral.

4. The method of claim 3 wherein said grade is the calculated loss in a logarithmic scale.

5. The method of claim 3 wherein said grade is a function of the loss converted to a linear scale.

6. The method of claim 3 wherein said grade is a function of the unwanted wave functions.

7. The method of claim 1 wherein said actual profile is acquired through an interferometric microscope.

8. The method of claim 1 wherein said actual profile is acquired through a contact profiler.

9. The method of claim 1 wherein said optical element exhibits circular symmetry.

10. The method of claim 1 wherein said optical element comprises a surface chosen from the group consisting of a nominally flat dielectric surface, a curved dielectric surface, a reflective surface, a diffractive surface and a refractive surface.

11. An apparatus for inspecting optical components comprising:
a surface profiler capable of measuring the actual surface profile of an optical element and a computing platform in data communication with said surface profiler, whereby
the expected field at the input to said optical element and the design output field is input to said computing platform, and whereby
said computing platform calculates an expected actual output field based on said actual profile, and further
calculates an overlap integral between said expected design output field and said expected actual output field.

12. The apparatus of claim 11 further involving a display being in data communication with said computing platform, whereby a function of said overlap integral is displayed on said display thus indicating a grade for said optical element.

13. The apparatus of claim 12 wherein said grade is the calculated loss expressed in a logarithmic scale.

14. The apparatus of claim 12 wherein said grade is a function of the loss converted to a linear scale.

15. The apparatus of claim 12 wherein said grade is a function of the unwanted wave functions.

16. The apparatus of claim 11 wherein said surface profiler comprises an interferometric microscope.

17. The apparatus of claim 11 wherein said surface profiler comprises a contact measuring apparatus.

18. The apparatus of claim 11 wherein said optical element exhibits circular symmetry.

19. The apparatus of claim 11 wherein said optical element comprises a surface chosen from the group consisting of a nominally flat dielectric surface, a curved dielectric surface, a reflective surface, a diffractive surface and a refractive surface.

20. A method of providing feedback to the production of an optical element comprising the steps of:
loading the design profile of the optical element;
loading an expected design output field;
acquiring the actual profile of said optical element;
calculating a weighted difference between the design height and the actual height of said optical element, whereby said weighting comprises said expected design output.
